(19) United States
(12) Patent Application Publication
(10) Pub. No.: US 2012/0169922 A1
(43) Pub. Date: Jul. 5, 2012

(54) CAMERA MODULE

(75) Inventors: WEN-CHIH WANG, Tu-Cheng (TW); MING-YU DENG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/092,157

(22) Filed: Apr. 22, 2011

(30) Foreign Application Priority Data
Dec. 29, 2010 (CN) 201010612234.3

(51) Int. Cl. H04N 5/225

(52) U.S. Cl. 348/374; 348/E05.024

(57) ABSTRACT

A camera module includes a lens assembly and a base board assembly. The lens assembly includes a lens, an internally threaded seat, and a barrel receiving the lens. The base board assembly includes a printed circuit board and a light sensing chip for receiving light through the lens. The seat defines a receiving cavity at least partially receiving the printed circuit board and the light sensing chip.

### BACKGROUND

1. Technical Field

The present disclosure generally relates to camera modules, and particularly to a camera module including a base board assembly.

2. Description of Related Art

Many camera modules used in electronic devices include a base board assembly and a lens assembly. The base board assembly includes a printed circuit board and a light sensing chip mounted on the printed circuit board. However, the camera module often occupies a larger volume due to its width, and cannot be used in smaller electronic devices.

Therefore, there is room for improvement within the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views, and all the views are schematic.

FIG. 1 is a cross section view of an embodiment of a camera module, and the camera module includes a base board assembly.

FIG. 2 is a top view of the base board assembly of the camera module shown in FIG. 1.

### DETAILED DESCRIPTION

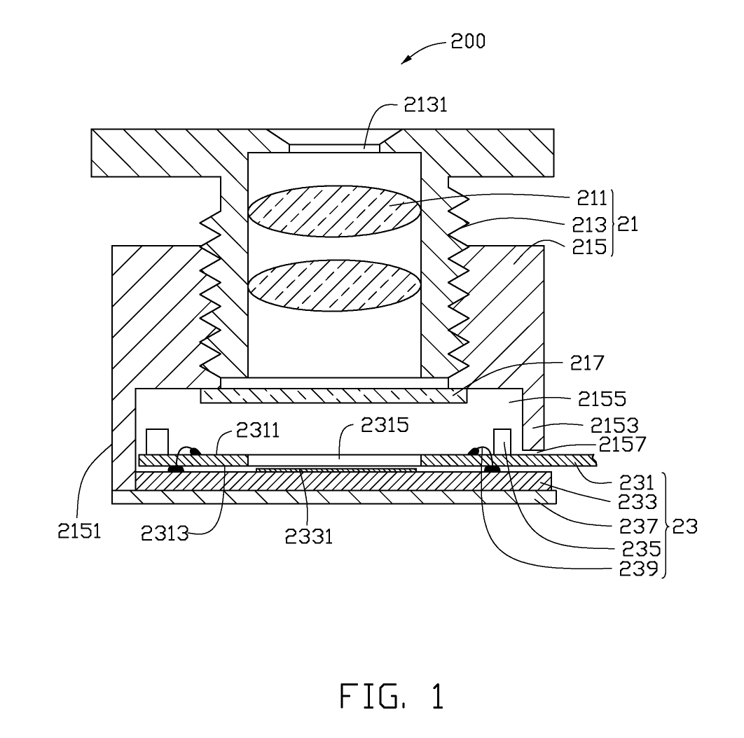

Referring to FIG. 1, a camera module 200 includes a lens assembly 21 and a base board assembly 23. The lens assembly 21 includes at least one lens 211, an externally threaded barrel 213 receiving the at least one lens 211, an internally threaded seat 215, and a filter 217. The barrel 213 defines a through hole 2131 for light passing through to the lens 211. The barrel 213 can be threadedly mounted on the seat 215. The seat 215 forms a first sidewall 2151 and a second sidewall 2153 at an end thereof. A length of the first sidewall 2151 exceeds that of the second sidewall 2153. The first sidewall 2151 and the second sidewall 2153 cooperatively define a receiving cavity 2155. The filter 217 is mounted in the receiving cavity 2155 and aligned with the lens 211, to eliminate or block infrared rays from the through hole 2131, thus improving imaging quality.

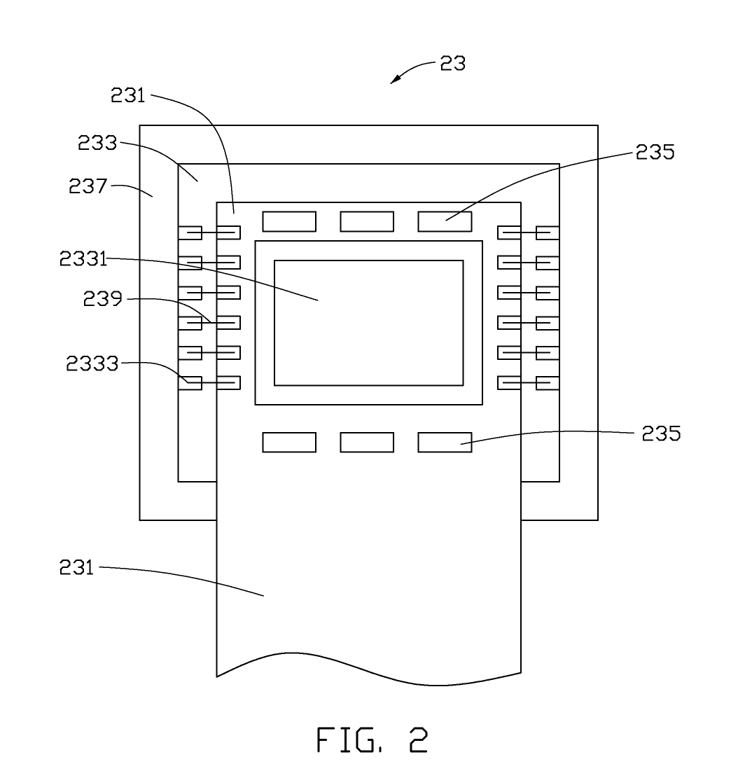

Also referring to FIG. 2, the base board assembly 23 includes a printed circuit board (PCB) 231, a light sensing chip 233, an electronic component 235, a reinforcement sheet 237, and a plurality of wires 239. In the illustrated embodiment, the PCB 231 is a flexible PCB. The PCB 231 includes a first surface 2311 where the wires 239 are connected, and a second surface 2313 opposite to the first surface 2311. The circuit board 231 forms a plurality of welding joints (not labeled) to fix the wires 239. The PCB 231 defines a passage 2315 at a central area thereof. The light sensing chip 233 includes a light sensing zone 2331. The light sensing chip 233 is mounted on the second surface 2313 of the PCB 231. The wires 239 electrically interconnect the light sensing chip 233 and a plurality of gold fingers (not labeled), and the light sensing zone 2331 faces the passage 2315. The electronic components 235 are mounted on the first surface 2311 of the PCB 231. The reinforcement sheet 237 is mounted on a surface of the light sensing chip 233 away from the PCB 231 and partially shields the light sensing chip 233 for protecting the light sensing chip 233. An end of the reinforcement sheet 237 exceeds the light sensing chip 233 and is connected to the first sidewall 2311. The second sidewall 2153 and the light sensing chip 233 cooperatively define a channel 2157 therebetween. The PCB 231 passes through the channel 2157 and is connected to a display (not shown). In the illustrated embodiment, the PCB 231 is disposed between the lens 211 and the light sensing chip 233. The light sensing chip 233 forms a plurality of welding pads 2333 arranged in two rows adjacent at two edges of the PCB 231, respectively. An end of each wire 239 is connected to one of the welding pads 2333 by inner lead bonding technology, and the other ends of the wires 239 are connected to the gold fingers of the PCB 231 also by inner lead bonding technology, for electrically connecting the PCB 231 to the light sensing chip 233, thus a width of the printed circuit board 231 is minimized.

Finally, while various embodiments have been described and illustrated, the disclosure is not to be construed as being limited thereto. Various modifications can be made to the embodiments by those skilled in the art without departing from the true spirit and scope of the disclosure as defined by the appended claims.

What is claimed is:

1. A camera module, comprising:
a lens assembly comprising at least one lens, an internally threaded seat, and a barrel receiving the at least one lens; and
a base board assembly, wherein the base board assembly comprises a printed circuit board and a light sensing chip for receiving light through the lens, and the seat defines a receiving cavity at least partially receiving the printed circuit board and the light sensing chip.

2. The camera module of claim 1, wherein the seat forms a first sidewall and a second sidewall opposite to the first sidewall at an end of the seat, and the receiving cavity is defined between the first sidewall and the second sidewall.

3. The camera module of claim 2, wherein a length of the first sidewall exceed the length of the second sidewall, the base board assembly is fixed on the first sidewall, and the second sidewall and the light sensing chip cooperatively define a channel therebetween for the printed circuit board passing through.

4. The camera module of claim 2, wherein the printed circuit board is positioned between the light sensing chip and the lens, and the printed circuit board defines a through hole corresponding to the lens.

5. The camera module of claim 4, wherein the printed circuit board comprises a first surface and the second surface opposite to the first surface, the light sensing chip forms a plurality of welding pads, the welding pads being connected to the printed circuit board by wires on the first surface, and the printed circuit board is mounted on the second surface.

6. The camera module of claim 5, wherein the wires are fixed on the printed circuit board and the welding pads by inner lead bonding technology, respectively.

7. The camera module of claim 4, wherein the base board assembly further comprises a reinforcement sheet on a surface of the light sensing chip away from the printed circuit board.

8. The camera module of claim 7, wherein an end of the reinforcement sheet exceeds the light sensing chip and is connected to the first sidewall.

9. The camera module of claim 1, further comprising a filter received in the receiving cavity.
